(19) United States
(12) Patent Application Publication
(10) Pub. No.: US 2007/0269238 A1
(43) Pub. Date: Nov. 22, 2007

(54) TONER CARTRIDGE

(75) Inventor: Tsutomu Sato, Izunokuni-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/749,280

(22) Filed: May 16, 2007

(30) Foreign Application Priority Data
May 18, 2006 (JP) 2006-139192

(51) Int. Cl. G03G 15/08

(52) U.S. Cl. 399/263

(57) ABSTRACT

A toner cartridge inserted in an image forming apparatus and supplying toner to the image forming apparatus comprises a container which contains the toner and provided with a discharging opening for discharging the contained toner, the container having a shape with a predetermined curvature at a bottom part, a conveying member which conveys the toner in the container to the discharging opening, an agitating member which rotates centering on a rotational axis in the container, and agitates the toner contained in the container and a sheet member provided in the agitating member such that a front edge part abuts the bottom part of the container, the sheet member having the front edge part which is formed with a part having substantially the same curvature as the bottom part of the container.

### CROSS-REFERENCE TO RELATED APPLICATIONS

This application is based upon and claims the benefit of priority from prior Japanese Patent Application No. 2006-139192, filed May 18, 2006, the entire contents of which are incorporated herein by reference.

### BACKGROUND OF THE INVENTION

1. Field of the Invention

The present invention relates to a toner cartridge for supplying toner to an image forming apparatus.

2. Description of the Related Art

As a conventional toner cartridge, there is one which has a container in which a discharging opening for housing toner and discharging the toner inside is provided, and a mixer journaled in the container in a rotatable manner and conveys the toner contained in a container along an inner wall while agitating the toner by rotational drive and sends out the tone from the discharging opening. A screw is configured such that an outer periphery part of the screw is arranged at a position close to the inner wall of the container.

However, in the conventional toner cartridge described above, a gap is formed between the mixer and the inner wall of the container. Therefore, the toner accumulates in the gap between the mixer and the inner wall of the container as a remaining amount of the toner in the container becomes little. This leads to a problem that the accumulated toner cannot be discharged.

In order to resolve the above problem, there is a toner cartridge including: a container which contains the toner and provided with a discharging opening for discharging the contained toner; and a agitating member which is connected to a rotational axis journaled in the container and is for sending out the toner from a sending out opening by conveying the toner along an inner wall while agitating the toner contained in the container by the rotational axis rotationally driving, wherein the agitating member includes a base part having a predetermined elastic deformation on a side of the rotational axis and a conveying member which is arranged outside the base part in a radial direction, rubs the inner wall of the container, and has a front edge part having larger elastic deformation than the base part (for example, refer to Jpn. Pat. Appln. Publication No. 10-282774).

However, in this case, when the front edge part of the conveying member rubs the inner wall of the container, stress is applied to the toner accumulated on the inner wall by sliding friction between the front edge part and the container. Thereby, there is a case that the properties of the toner changes and clumps (so-called coarse powder) are generated. Such generation of clumps has led to generation of a clump image on a printing surface of paper, and been an interference in improving image quality in an image forming processing.

The present invention is invented in order to solve the above problem. An object of the present invention is to provide a toner cartridge capable of preventing the toner from remaining at a bottom part of the toner container in the toner cartridge inserted in the image forming apparatus, and thereby, contributing to improvement of image quality in an image forming processing.

### BRIEF SUMMARY OF THE INVENTION

According to one aspect of the present invention, there is provided a toner cartridge comprising: a container which contains the toner and provided with a discharging opening for discharging the contained toner, the container having a shape with a predetermined curvature at a bottom part, a conveying member which conveys the toner in the container to the discharging opening, an agitating member which rotates centering on a rotational axis in the container, and agitates the toner contained in the container and a sheet member provided in the agitating member such that a front edge part abuts the bottom part of the container, the sheet member having the front edge part which is formed with a part having substantially the same curvature as the bottom part of the container.

### BRIEF DESCRIPTION OF THE SEVERAL VIEWS OF THE DRAWING

FIG. 1 is a schematic view showing an internal structure of an image forming apparatus according to one embodiment of the present invention;

FIG. 2 is a perspective view showing a toner cartridge according to the present embodiment viewed from above a front side;

FIG. 3 is a plan view showing the toner cartridge according to the present embodiment viewed from above;

FIG. 4 is a transverse cross-sectional view showing an internal structure of the toner cartridge according to the present embodiment;

FIG. 5A is a vertical cross-sectional view showing the internal structure of the toner cartridge according to the present embodiment;

FIG. 5B is a vertical cross-sectional view showing the internal structure of the toner cartridge according to the another embodiment;

FIG. 6 is a perspective view of an inside of the image forming apparatus according to the present embodiment viewed from above a front side; and

FIG. 7 is an enlarged vertical cross-sectional view showing an inside configuration of the toner cartridge according to the present embodiment.

### DETAILED DESCRIPTION OF THE INVENTION

Hereinafter, a preferred embodiment for carrying out the present invention will be described.

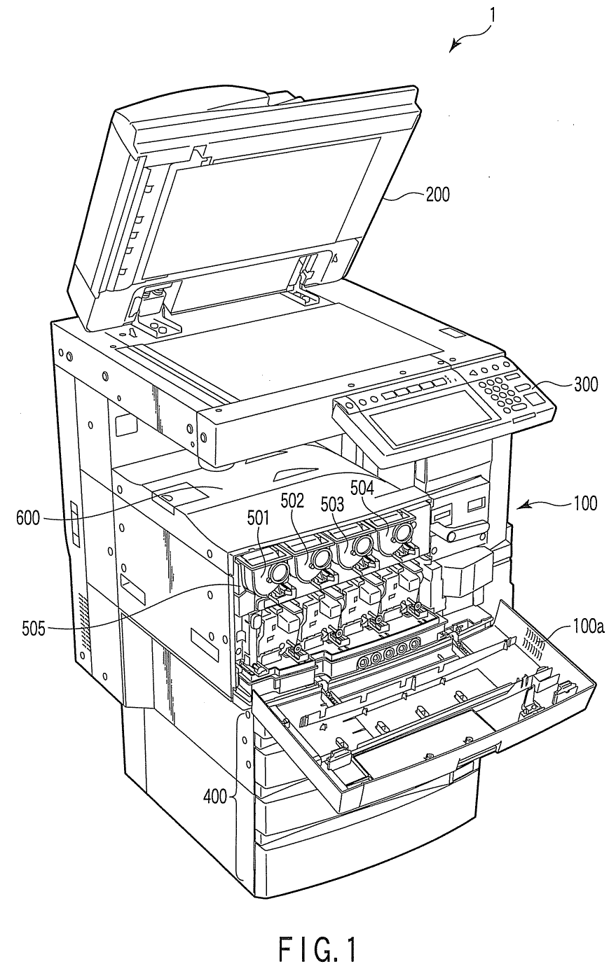

FIG. 1 is a perspective view of a schematic view showing an internal structure of an image forming apparatus 1 according to an embodiment of the present invention. As shown in FIG. 1, the image forming apparatus 1 is a color copier of a quadruple tandem system. The image forming apparatus 1 includes a copier main body 100, a platen cover 200, a control panel 300, and a plurality of paper feeding cassettes 400.

The copier main body 100 plays a major role in image forming, and has a cover 100a provided on a front surface thereof in an openable and closable manner. When the cover 100a is opened, first to fourth toner cartridges 501 to 504 are found to be arranged in alignment on an upper portion side of the cover 100a. The platen cover 200 is provided on the copier main body 100 in an rotatable manner with one side edge as a rotational center. The control panel 300 is an input unit for copy operation and is provided on a top surface of the copier main body 100. The paper feeding cassette 400 is for containing paper and is provided on a lower side of the copier main body 100 in a removable manner. In addition, a paper delivering unit 600 is provided on top of a portion where the first to fourth toner cartridges 501 to 504 are provided.

Each of the first to fourth toner cartridges 501 to 504 is provided in a removable manner in a cartridge holding mechanism 505. The first to fourth toner cartridges 501 to 504 are for supplying toner of yellow, magenta, cyan, and black.

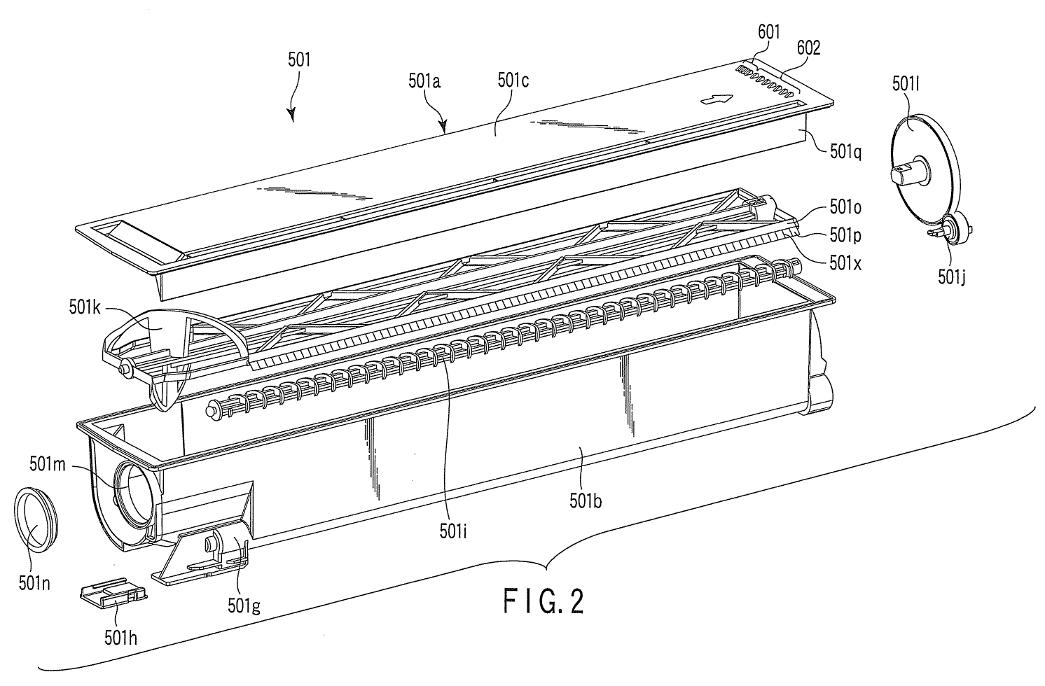

Next, a configuration of the first toner cartridge 501 will be described with reference to FIG. 2. Description of configurations of the second to fourth toner cartridges 502 to 504 will be omitted, since such configurations are almost same as the configuration of the first toner cartridge 501.

FIG. 2 is a perspective view showing an entire configuration of the first toner cartridge 501 according to the present embodiment viewed from a front surface side. Here, a surface with a cap 501n of the first toner cartridge 501 is the front surface side, and a surface with a mixer gear 501l as an agitating member is a rear side.

As shown in FIG. 2, the first toner cartridge 501 includes a cartridge main body 501a working as a toner container for containing the toner. The cartridge main body 501a is configured with a container body 501b and a lid body 501c. Also, first and second discriminating protrusion units 601 and 602 for discriminating toner information are provided on a rear side of the cartridge main body 501a.

The container body 501b has a U-shaped cross section. The lid body 501c has a rectangular plate shape. On a front surface side of the container body 501b, there is provided a discharging unit 501g which discharges the toner in the cartridge main body 501a and works as a toner supplying opening for supplying the toner in the image forming apparatus 1. The discharging unit 501g projects downwardly from a bottom surface of the container body 501b. On a bottom edge part of the discharging unit 501g, there is provided a shutter 501h for opening and closing a discharging opening (not shown) formed on the discharging unit 501g.

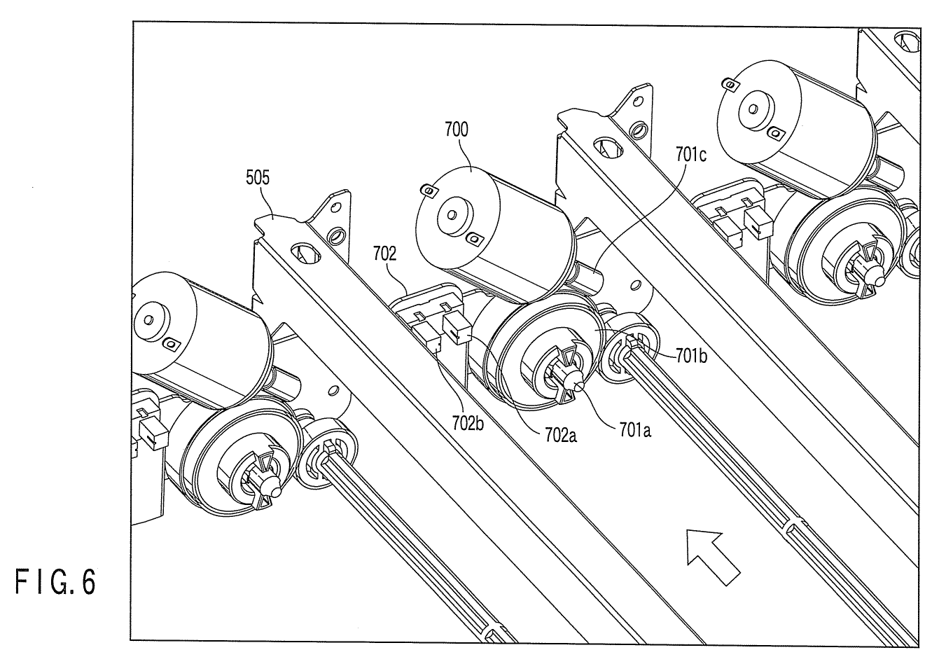

At the inner bottom of the containing unit 501b, there is provided a screw 501i working as a conveying member for conveying the toner in the cartridge main body 501a to the discharging unit 501g. On an end part on a rear surface side of the screw 501i, there is provided a coupling member 501j working as a driving member. The coupling member 501j is connected to a driving apparatus 700 shown in FIG. 6 provided in the copier main body 100, and rotationally driven every time the toner is supplied.

Inside the cartridge main body 501a, there is provided a mixer 501k for agitating the toner in the cartridge main body 501a. At an end part on a rear surface of the mixer 501k, there is provided a mixer gear 501l. The mixer gear 501l meshes with the coupling member 501j working as a gear provided in the screw 501i. When the screw 501i is rotated, the mixer gear 501k is configured to rotate in association therewith.

On a front surface side of the container body 501b, there is formed a filling opening 501m used for filling the toner in the cartridge main body 501a. The filling opening 501m has a circular shape, and is sealed with the cap 501n.

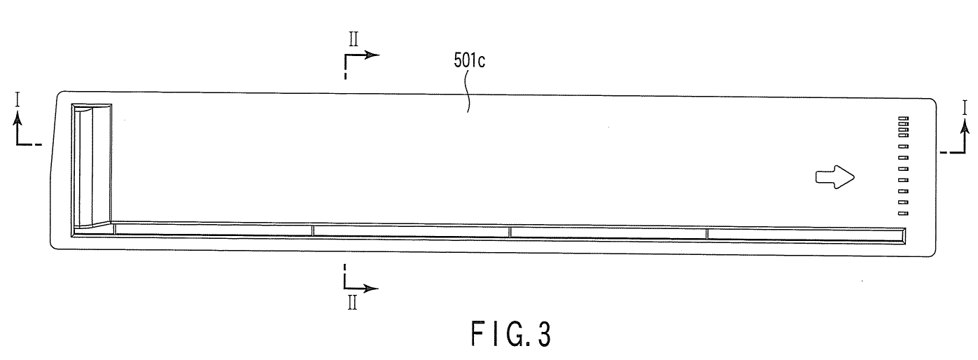

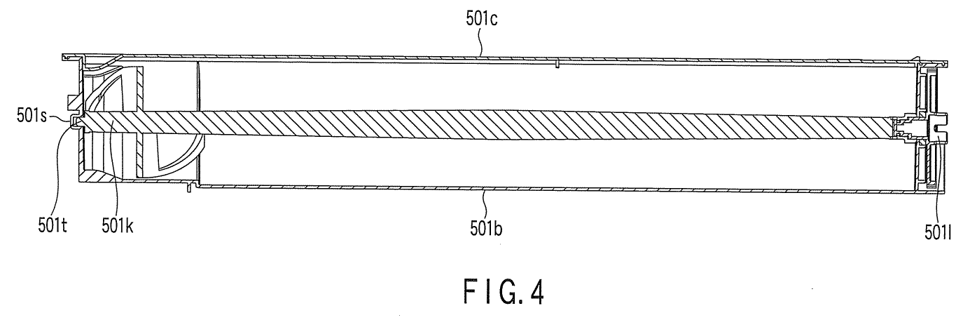

FIG. 3 is a view of the first toner cartridge 501 viewed from above a top surface. In addition, FIG. 4 shows a cross-sectional view of the first toner cartridge 501 cut along the line I-I in FIG. 3. The mixer 501k is fixed as described below. On a rear side surface of the first toner cartridge 501, the mixer 501k connects with the mixer gear 501l with a coupling unit interposed therebetween. In addition, on a front surface side of the first toner cartridge 501, the mixer 501k has a convex part 501t formed in a convex shape at an end part, and fits in a concave part 501s provided on a front surface side of the container body.

Here, an inner diameter of the concave part 501s is little larger than an outer diameter of the convex part 501t. For this reason, when the mixer 501k rotates to agitate the toner, the toner enters into a little gap between the convex part 501t and the concave part 501s. In this manner, friction between the convex part 501t and the concave part 501s is reduced, and the mixer 501k can rotate smoothly.

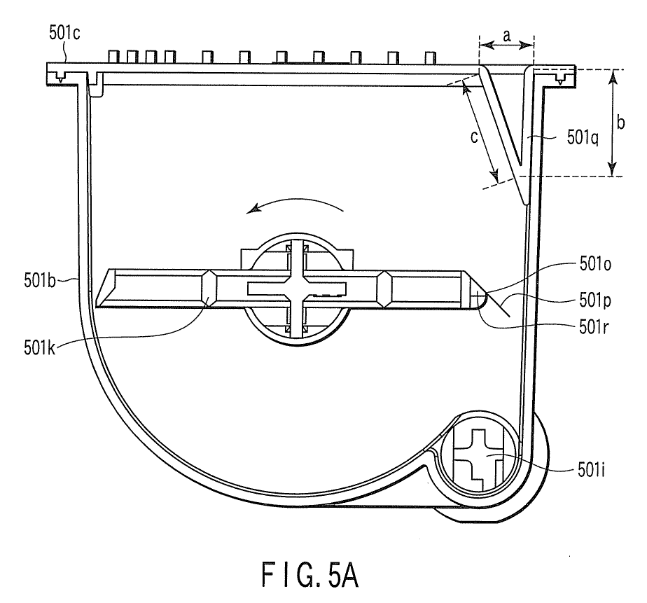

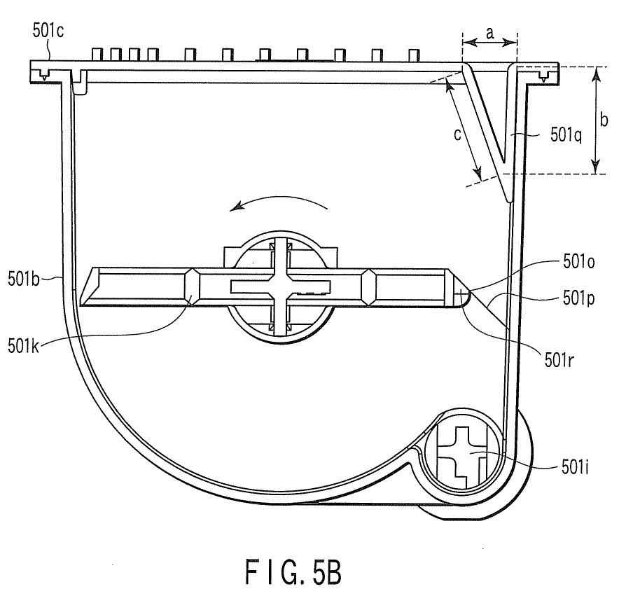

FIG. 5A shows a cross-sectional view of the first toner cartridge 501 cut along the line II-II in FIG. 3. The lid body 501c has a lid body protrusion part 501q. The lid body protrusion part 501q is provided at an upper edge of the container body 501b when the lid body 501c is inserted in the container body 501b. The lid body protrusion part 501q is a protrusion having a cross-sectional triangle shape enclosed by a line a, a line b, and an oblique line c. The line a has a predetermined length in a width direction from a connection of the lid body 501c and the container body 501b. The line b has a predetermined length from the connection of the lid body 501c and the container body 501b to the container body 501b and crosses the line a at a substantial right angle. The oblique line c is determined by the above two sides.

In addition, a surface enclosed by the line b having a predetermined length of the lid body protrusion part 501q and a longitudinal direction of the lid body 501c is formed such that the lid body 501c abuts the container body 501b without having any gap interposed therebetween when the lid body 501c is inserted in the container body 501b.

When the amount of the toner in the toner cartridge main body 501a becomes little, a gap appears between an outer periphery of the mixer 501k and an inner wall of the container body 501b. Therefore, the toner remaining in the gap cannot be conveyed by the mixer 501k. However, in the present embodiment, the lid body protrusion part 501q fills the gap appearing in the connection of the container body 501b and the lid body 501c. Therefore, the toner can be prevented from remaining in the gap.

Further, the lid body protrusion part 501q is provided with a surface having the oblique line c. Therefore, the toner adhered to the lid body protrusion part 501q easily flows down to an inside bottom of the container body 501b, and adherence of the toner hardly occurs.

In addition, as shown in FIG. 5A, a sweep sheet 501o is fixed on a mounting surface 501r which is an outer periphery part of the mixer 501k. In addition, a sweep part 501p, which is a free end not fixed on the mounting surface 501r of the sweep sheet 501o, projects in a further extended direction from an outer periphery part of the mixer 501k. The mixer 501k rotates counterclockwise in FIG. 5A which is a cross-sectional view of the first toner cartridge 501 viewed from a front surface side. For this reason, the sweep part 501p abuts the inner bottom of the container body 501b.

Further, as shown in FIG. 2, the sweep sheet 501o is inserted on the mounting surface 501r of the mixer 501k over a longitudinal direction. In addition, a plurality of cut parts 501x shown in FIG. 2 are formed on the sweep sheet 501o in a direction substantially parallel to a rotational axis with predetermined intervals, here intervals of 5 mm, over a whole length in a width direction. For this reason, divided parts of the sweep sheet 501o can change elasticity independently.

As shown in FIG. 5A, the sweep sheet 501o is affixed to the mounting surface 501r of an outside edge part of the mixer 501k in a rotational radial direction in an angle inclined at around 45 degrees from a rotational radial direction to a rotational radial rear side of the mixer 501k on a flat surface which crosses the rotational axis of the mixer 501k at substantial right angle. The sweep sheet 501o is inserted on the mounting surface 501r with a double-faced tape, etc. on one end of the sweep sheet 501o. The sweep sheet 501o is a band-shaped PET sheet having a thickness dimension of around 0.05 mm which can be elastically changed.

When a driving force is transmitted from the driving apparatus 700 shown in FIG. 6 to rotationally drive the coupling member 501j, the screw 501i is rotationally driven in an integrated manner, and the mixer 501k is rotationally driven via the mixer gear 501l. In this manner, the mixer 501k agitates and sends out the toner to the screw 501i at the same time. The screw 501i conveys the sent-out toner to the discharging unit 501g. Then, the toner is discharged from the discharging unit 501g. When the first toner cartridge 501 just starts to be used, the toner amount in the container body 501b is large. Even when the mixer 501k and the sweep sheet 501o rotate in an integrated manner, the toner in contact with the sweep part 501p passes through the cut parts 501x and flows toward a rear direction of the sweep part 501p.

Therefore, the sweep sheet 501o never interferes with the rotation of the mixer 501k.

In addition, when the toner amount of the first toner cartridge 501 becomes small, a gap is formed between the outer periphery part of the mixer 501k and the inner wall of the container body 501b. Therefore, the toner remaining in the gap cannot be conveyed by the mixer 501k. However, the sweep sheet 501o abuts the inner bottom of the container body 501b.

Therefore, the toner remaining in the gap can be sent out to the screw 501i. In this way, an amount of the remaining toner in the first toner cartridge 501 can be reduced.

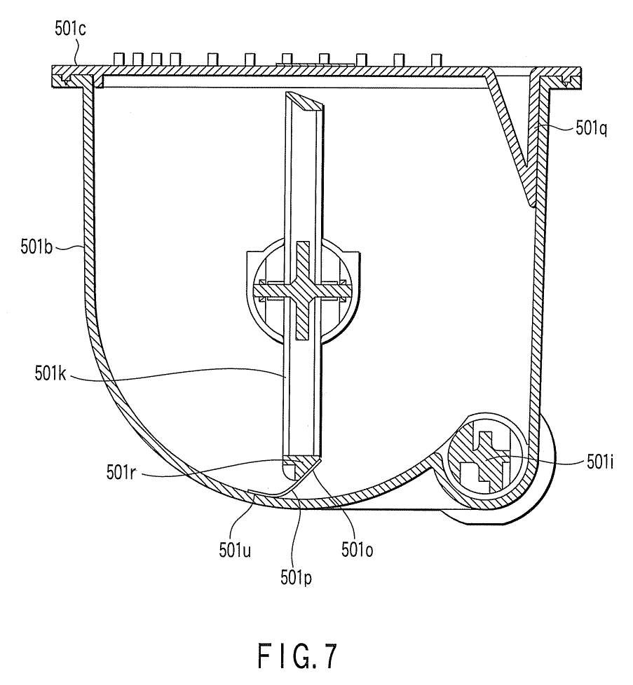

Next, a shape of the sweep sheet 501o which is an important part of the present embodiment will be described. FIG. 7 shows a cross-sectional view of the toner cartridge 501 cut along the line II-II in FIG. 3. Here, in the sweep sheet 501o which is a free edge not fixed on the mounting surface 501r, a part abutting a bottom part of the container 501b of the sweep part 501p is particularly considered as a front edge part 501u.

FIG. 7 is a view in which the front edge part 501u of the sweep sheet 501o abuts the bottom part of the container 501b. As to a cross-sectional shape of the front edge part 501u, an outside edge of the front edge part 501u abutting the bottom part of the container 501b is formed in the same curvature as, for example, the bottom part of the container 501b in advance. In the present embodiment, the bottom part of the container 501b of the first toner cartridge 501 is formed with a radius of around 33 mm. For this reason, the front edge part 501u of the sweep sheet 501o is also formed with substantially the same curvature as the bottom part of the container 501b. In addition, a length dimension of the front edge part 501u of the sweep sheet 501o which abuts an inner wall having a semicylindrical shape at the bottom part of the container 501 of the first toner cartridge 501 is preferably 1.1 mm. In order to fix the front edge part 501u to this dimension, a length dimension of the sweep part 501p is set at 5.4 mm.

That is, the mixer 501k rotates, and together therewith, the sweep sheet 501o and the front edge part 501p also rotates counterclockwise. The front edge part 501u is formed so as to just smoothly abutting the bottom part of the container 501b. For this reason, even if the front edge part 501u rotates for one complete revolution centering on an axis of the mixer 501k in association with a rotation of the mixer 501k, the front edge part 501p only abuts the bottom part of the container 501b without pressing hard. Therefore, the front edge part 501p is never elastically changed by abutting the container 501b and the lid body 501c. In addition, the front edge part 501p is formed with substantially the same curvature as the bottom part of the container 501b in advance. Therefore, when a sheet without curvature is used, the sweep sheet 501o never abuts the bottom part of the container 501b in such a way as striking the bottom part. Also, unnecessary vibration is never applied to the first cartridge 501 in association with a rotation of the sweep sheet 501o.

Therefore, by having the above-described shape, the front edge part 501u never generates friction with the container 501b when the mixer 501k rotates. Also, the front edge part 501u never resist the rotation of the mixer 501k. In addition, since the front edge part 501u does not generate friction with the container 501b, the properties of the toner can be prevented from changing when the front edge part 501u sweeps out the toner. For this reason, generation of clumps can be prevented, and generation of a clump image on a printing surface of paper is also prevented. Thereby, image quality in the image forming processing can be improved.

In this case in the example shown in FIG. 5A, the length of the sweep part 501p is 5.4 mm. As a modified example, an example in which the length is changed to 10 mm will be explained, with reference to FIG. 5B. The sweep part 501p abuts an inner right side of the container body 501b, viewed from the front surface side of the toner cartridge 501, in addition to the inner bottom of the container body 501b. The sweep part 501p can brush the toner adhered to the inner right side of the container body 501b, because the sweep part 501p abuts the inner right side of the container body 501b. By increasing the sweep part 501p in length, the amount of remaining toner in the cartridge body 501b can be further decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A toner cartridge inserted in an image forming apparatus and supplying toner to the image forming apparatus, comprising:
a container which contains the toner and provided with a discharging opening for discharging the contained toner, the container having a shape with a predetermined curvature at a bottom part;
a conveying member which conveys the toner in the container to the discharging opening;
an agitating member which rotates centering on a rotational axis in the container, and agitates the toner contained in the container; and
a sheet member provided in the agitating member such that a front edge part abuts the bottom part of the container, the sheet member having the front edge part which is formed with a part having substantially the same curvature as the bottom part of the container.

2. The toner cartridge according to claim 1, wherein the sheet member abuts at least one of either the bottom part of the container or a side part of the container.

3. The toner cartridge according to claim 2, wherein the sheet member is formed from an outer periphery of the agitating member through the front edge part of the sheet member with the curvature in an opposite direction with respect to a rotational direction of the agitating member rotating centering on the rotational axis.

4. The toner cartridge according to claim 3, wherein the sheet member has a plurality of cut parts cut in the sheet member in a width direction with intervals in a longitudinal direction.

5. The toner cartridge according to claim 4, wherein the sheet member elastically changes.

6. The toner cartridge according to claim 5, wherein the container has a slant face that is formed from an upper part of the container to the side part of the container body along a longitudinal direction of the container as the slant face covers a joint of the upper part of the container and the side part of the container.

7. A toner cartridge inserted in an image forming apparatus and supplying toner to the image forming apparatus, comprising:
a contain means for containing the toner and provided with a discharge means for discharging the contained toner, the contain means having a shape with a predetermined curvature at a bottom part;
a convey means for conveying the toner in the contain means to the discharge means;
an agitate means for rotating centering on a rotational axis in the contain means, and agitating the toner contained in the contain means; and
an abut means for abutting the bottom part of the contain means, wherein the abut means is provided in the abut means such that a front edge part which is formed with a part having substantially the same curvature as the bottom part of the contain means.

8. The toner cartridge according to claim 7, wherein the abut means abuts at least one of either the bottom part of the contain means or a side part of the contain means.

9. The toner cartridge according to claim 8, wherein the abut means is formed from an outer periphery of the agitate means through the front edge part of the abut means with the curvature in an opposite direction with respect to a rotational direction of the agitate means rotating centering on the rotational axis.

10. The toner cartridge according to claim 9, wherein the abut means has a plurality of cut parts cut in the abut means in a width direction with intervals in a longitudinal direction.

11. The toner cartridge according to claim 10, wherein the abut means elastically changes.

12. The toner cartridge according to claim 11, wherein the contain means has a slant face that is formed from an upper part of the contain means to the side part of the contain means along a longitudinal direction of the contain means as the slant face covers a joint of the upper part of the contain means and the side part of the contain means.

13. An image forming apparatus, which has a toner cartridge inserted therein to supplying toner to the image forming apparatus, said apparatus comprising:
a container which contains the toner and provided with a discharging opening for discharging the contained toner, the container having a shape with a predetermined curvature at a bottom part;
a conveying member which conveys the toner in the container to the discharging opening;
an agitating member which rotates centering on a rotational axis in the container, and agitates the toner contained in the container; and
a sheet member provided in the agitating member such that a front edge part abuts the bottom part of the container, the sheet member having the front edge part which is formed with a part having substantially the same curvature as the bottom part of the container. a driving apparatus which drives the agitating member.

14. The image forming apparatus according to claim 13, wherein the sheet member abuts at least one of either the bottom part of the container or a side part of the container.

15. The image forming apparatus according to claim 14, wherein the sheet member is formed from an outer periphery of the agitating member through the front edge part of the sheet member with the curvature in an opposite direction with respect to a rotational direction of the agitating member rotating centering on the rotational axis.

16. The image forming apparatus according to claim 15, wherein the sheet member has a plurality of cut parts cut in the sheet member in a width direction with intervals in a longitudinal direction.

17. The image forming apparatus according to claim 16, wherein the sheet member elastically changes.

18. The image forming apparatus according to claim 17, wherein the container has a slant face that is formed from an upper part of the container to the side part of the container body along a longitudinal direction of the container as the slant face covers a joint of the upper part of the container and the side part of the container.
